(19) United States
(12) Patent Application Publication
(10) Pub. No.: US 2013/0229500 A1
(43) Pub. Date: Sep. 5, 2013

(54) METHODS AND APPARATUS FOR UPGRADING A PROJECTOR TO DISPLAY THREE-DIMENSIONAL CONTENT

(71) Applicants: Jesus Barcons-Palau, Sunnyvale, CA (US); Jens Cahnbley, Princeton Junction, NJ (US); Gad Moshe Berger, Dayton, NJ (US)

(72) Inventors: Jesus Barcons-Palau, Sunnyvale, CA (US); Jens Cahnbley, Princeton Junction, NJ (US); Gad Moshe Berger, Dayton, NJ (US)

(21) Appl. No.: 13/885,523

(22) PCT Filed: Nov. 18, 2010
(86) PCT No.: PCT/US2010/003011

§ 371 Date: May 15, 2013

(51) Int. Cl. H04N 13/04

(52) U.S. Cl. CPC H04N 13/04
USPC 348/51

(57) ABSTRACT

An apparatus for upgrading a projector having a two-dimensional projector lens to display three-dimensional content includes a circular polarized filter having at least two polarized zones, and a motor having a shaft on which is mounted the filter. At least one light sensor is disposed in front of the two-dimensional projector lens for providing a spatial control output signal and a temporal control output signal. A processor controls a speed at which the filter is rotated around the shaft of the motor responsive to information determined from the spatial control output signal and the temporal control output signal, such that the filter is automatically adjusted to spin so as to respectively place an appropriate one of the at least two polarized zones of the filter in front of an applicable frame of the video sequence to obtain a polarization thereof representative of the three-dimensional content.

### BACKGROUND

For decades, two-dimensional (2D) display screens have been used to display video content to viewers. While such screens have managed to evolve over the years, a current direction of interest in display screens is towards three-dimensional (3D) display screens. With such interest, the development of ways to upgrade a projector to display three-dimensional content is also of interest.

### SUMMARY

These and other drawbacks and disadvantages of the prior art are addressed by the present principles, which are directed to methods and apparatus for upgrading a projector to display three-dimensional (3D) content.

According to one aspect, an apparatus is provided for upgrading a projector having a two-dimensional projector lens to display three-dimensional content. The apparatus includes a circular polarized filter having at least two polarized zones, and a motor having a shaft on which is mounted the circular polarized filter. The apparatus further includes at least one light sensor disposed in front of the projector lens for providing a spatial control output signal and a temporal control output signal. The apparatus further includes a processor for controlling a speed at which the circular polarized filter is rotated around the shaft of the motor responsive to information determined from the spatial control output signal and the temporal control output signal, such that the circular polarized filter is automatically adjusted to spin so as to respectively place an appropriate one of the two polarized zones of the circular polarized filter in front of an applicable frame of the video sequence to obtain a polarization thereof representative of the three-dimensional content.

According to another aspect, a method is provided for upgrading a projector having a two-dimensional projector lens to display three-dimensional content. The method includes providing a circular polarized filter having at least two polarized zones, and a motor having a shaft on which is mounted the circular polarized filter. The method further includes providing a spatial control output signal and a temporal control output signal. The method also includes controlling a speed at which the circular polarized filter is rotated around the shaft of the motor responsive to information determined from the spatial control output signal and the temporal control output signal, such that the circular polarized filter is automatically adjusted to spin so as to respectively place an appropriate one of the two polarized zones of the circular polarized filter in front of an applicable frame of the video sequence to obtain a polarization thereof representative of the three-dimensional content.

According to yet another aspect, an apparatus is provided for upgrading a projector having a two-dimensional projector lens to display three-dimensional content. The apparatus includes a circular polarized filter having at least two polarized zones, and a motor having a shaft on which is mounted the circular polarized filter. The apparatus further includes a user input device for receiving a user input and controlling a speed at which the circular polarized filter is rotated around the shaft of the motor responsive to the user input. The circular polarized filter is spun responsive to the user input so as to respectively place an appropriate one of the two polarized zones of the circular polarized filter in front of an applicable frame of the video sequence to obtain a polarization thereof representative of the three-dimensional content.

According to still another aspect, a method is provided for upgrading a projector having a two-dimensional projector lens to display three-dimensional content. The method includes providing a circular polarized filter having at least two polarized zones, and a motor having a shaft on which is mounted the circular polarized filter. The method further includes receiving a user input and controlling a speed at which the circular polarized filter is rotated around the shaft of the motor responsive to the user input. The circular polarized filter is spun responsive to the user input so as to respectively place an appropriate one of the two polarized zones of the circular polarized filter in front of an applicable frame of the video sequence to obtain a polarization thereof representative of the three-dimensional content.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram showing an exemplary apparatus for upgrading a projector to display three-dimensional content, in accordance with an embodiment;

FIG. 2 is a flow diagram showing an exemplary method for upgrading a projector to display three-dimensional content, in accordance with an embodiment;

FIG. 3 is a block diagram showing another exemplary apparatus for upgrading a projector to display three-dimensional content, in accordance with an embodiment; and

FIG. 4 is a flow diagram showing another exemplary method for upgrading a projector to display three-dimensional content, in accordance with an embodiment.

### DETAILED DESCRIPTION

The present principles are directed to methods and apparatus for upgrading a projector to display three-dimensional (3D) content. The present description illustrates the present principles. It will thus be appreciated that those skilled in the art will be able to devise various arrangements that, although not explicitly described or shown herein, embody the present principles and are included within its scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment,” as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

The present principles are directed to a method and apparatus for upgrading a two-dimensional (2D) projector to display three-dimensional (3D) content. The REALD 3D technology currently used on movie theaters involves using two polarized filters that are alternated in front of the projector lens synchronously with the frames. Thus, the left and right frames of the three-dimensional content will be polarized with one of the two polarized filters.

For example, in one embodiment, a light sensor (i.e., a photoresistor) set in front of a projector lens is considered. By using this sensor and some processing (if required), it can be possible to detect the frequency F and time in which frames are projected. Let us consider a small Direct Current (DC) motor, spinning at the same speed as F. Attached to this motor there is a circular filter, each half with a different polarization. By using another sensor, it is possible to know the instant at which the edge between the two polarized zones of the filter crosses a particular point. The circular filter is placed in front of the projector lens, and the system is automatically adjusted to spin at the proper speed to use one zone of the polarized filter per frame.

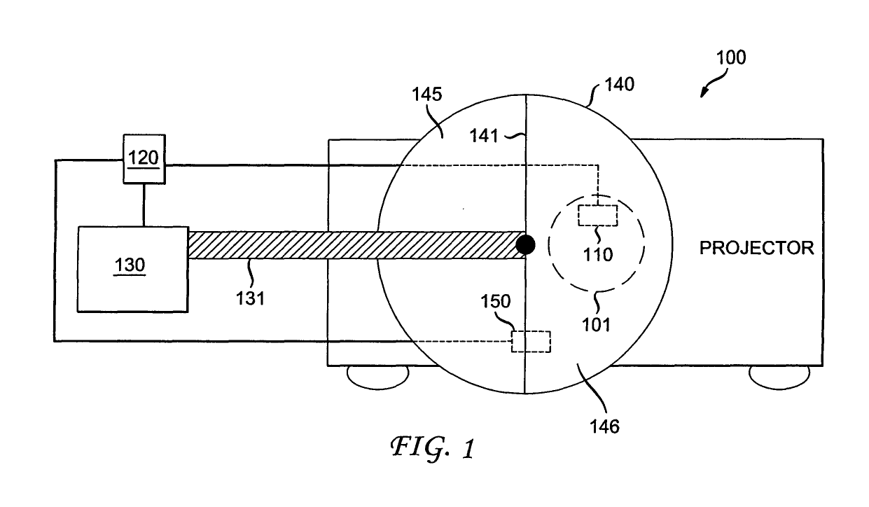

Turning to FIG. 1, an exemplary apparatus for upgrading a projector to display three-dimensional content is indicated generally by the reference numeral 100. The apparatus 100 includes a first light sensor 110, a processor 120, a Direct Current (DC) motor 130, a circular polarized filter 140, and a second light sensor 150. The circular polarized filter 140 is manufactured and/or otherwise provided to have at least two polarized zones thereon, namely at least a first polarized zone 145 and a second polarized zone 146, with at least one edge 141 separating the at least first and second zones 145 and 146.

The light sensor 110 is set in front and/or in proximity of a projector lens 101. An output (also interchangeably referred to herein as a “temporal control output signal”) of the light sensor 110 is connected in signal communication with a first input of the processor 120. The processor 120 determines, based on pre-specified criteria applied to the output of the light sensor 110, a frequency F and a time at which frames of a particular video sequence are projected during a sequential showing of the particular video sequence. The criteria can include, but is not limited to, information indicative of the presentation (displaying) of a new frame. Such information can include, but is not limited to, one or more new objects being displayed that were not displayed a set time earlier or one or more objects missing that were displayed a set time earlier, where the inclusion or omission can be judged as a new frame. Moreover, reappearing objects (i.e., there one instant, gone a set time later, only to reappear a set time there after) can be used as well to judge the presence of a new frame. Moreover, text, symbols, etc. (collectively referred to as characters herein after) can used to indicate the presence (displaying) of a new frame, where the characters are formatted into a display size that is small (e.g., smaller than the naked eye can see at close range), and the sensor 110 can read the same to determine when a new frame is being displayed. Of course, it is to be appreciated that the preceding criteria is merely illustrative and, thus, other criteria can be used as readily contemplated by one of ordinary skill in this and related arts, given the teachings provided herein. In this way, accurate temporal positioning of an appropriate one of the at least two polarized zones of the filter in front of an appropriate frame of the video sequence can be obtained. Thus, the output signal of the light sensor 110 can be considered a temporal control output signal.

The light sensor 150 is also set in front and/or in proximity of a projector lens 101. An output (also interchangeably referred to herein as a “spatial control output signal”) of the light sensor 150 is connected in signal communication with a second input of the processor 120. The processor 120 determines a time instant at which the edge 141 between the two polarized zones of the filter crosses a particular point. In this way, accurate spatial positioning of an appropriate one of the at least two polarized zones of the filter in front of an appropriate frame of the video sequence can be obtained. Thus, the output signal of the light sensor 150 can be considered a spatial control output signal.

As noted above, the circular polarized filter 140 is manufactured and/or otherwise provided to have at least two polarized zones thereon. The circular polarized filter 140 is attached to an output shaft 131 of the DC motor 130. An output of the processor 120 is connected in signal communication with a control input of the DC motor 130. The control input controls the speed at which the shaft 131 of the DC motor spins. The DC motor 130 is configured to spin at a speed equal and/or otherwise corresponding to the frequency F. In this way, the DC motor 130 spins so that the attached circular polarized filter 140 is automatically adjusted to spin at the proper speed which respectively places an appropriate one of the two polarized zones of the circular polarized filter 140 in front of an applicable frame of the video sequence to obtain a desired polarization thereof.

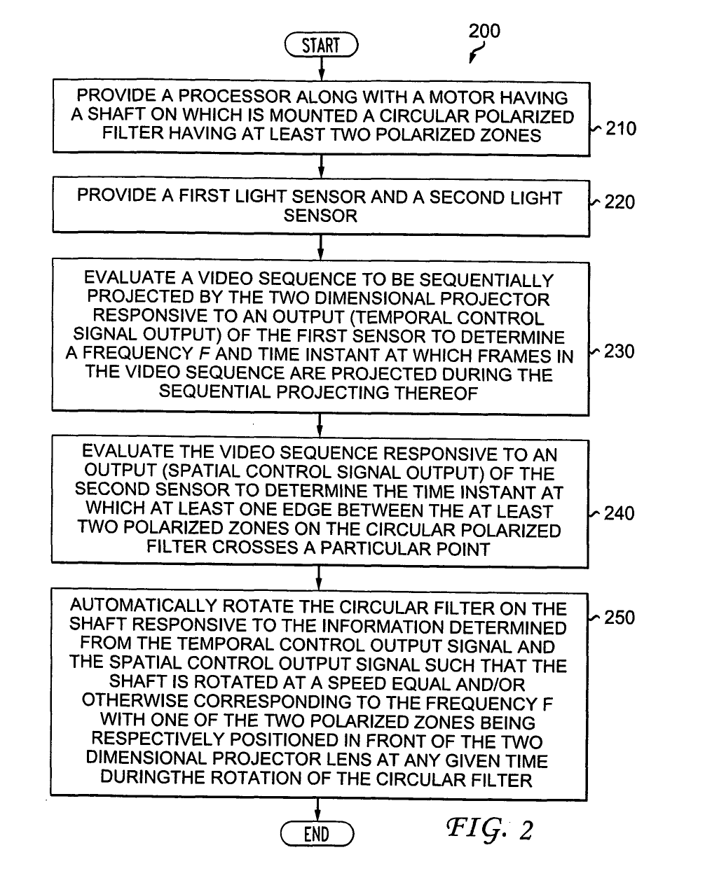

Turning to FIG. 2, an exemplary method for upgrading a projector to display three-dimensional content is indicated generally by the reference numeral 200. At step 210, a processor 120 is provided along with a motor 130 having a shaft 131 on which is mounted a circular polarized filter 140 having at least two polarized zones. At step 220, a first light sensor 110 and a second light sensor 150 are provided.

At step 230, a video sequence to be sequentially projected by the projector is evaluated responsive to an output of the first sensor 110 to determine a frequency F and time instant at which frames in the video sequence are projected during the sequential projecting thereof. The time instant can be the time instant corresponding to the displaying of the first frame of the video sequence, or can correspond to any other frame. It is to be appreciated that simply determining a single time instant at which a single frame is projected along with the frequency F allows for the readily determination of the corresponding time instants for other frames in the video sequence, presuming a fixed temporal distance between consecutive frames.

At step 240, the video sequence is evaluated responsive to an output of the second sensor 150 to determine the time instant at which the edge 141 between the at least two polarized zones on the circular polarized filter 140 crosses a particular point. The point can correspond to, for example, a location in between at least two frames or a location in between one frame, e.g., in between the top and bottom fields. Of course, other locations can also be used.

The former evaluation (as per step 230) can be considered to be a temporal evaluation in that timing information is determined there from, while the second evaluation (as per step 240) can be considered a spatial evaluation in that one or more correlations in space are determined. In any event, the results of both evaluations are used (at step 250) to rotate the circular filter 140 at the proper speed and so as to place the appropriate one of the two polarized zones at the proper location in front of the projection lens 101.

At step 250, the circular polarized filter 140 having the at least two polarized zones is automatically rotated on the shaft 131 of the DC motor 130 responsive to the information determined from the temporal control output signal and the spatial control output signal such that the shaft is rotated at a speed equal and/or otherwise corresponding to the frequency F, with one of the two polarized zones being respectively positioned in front of the projector lens 101 at any given time during the rotation of the circular filter.

Regarding another exemplary embodiment, an apparatus and/or method is configured to swap views. That is, using input from the user, the motor can spin faster or slower for a few instants in order to use an appropriate filter for a given view. The user input is used because the system does not know if it is using the proper filter for the frames that are being displayed through the projector.

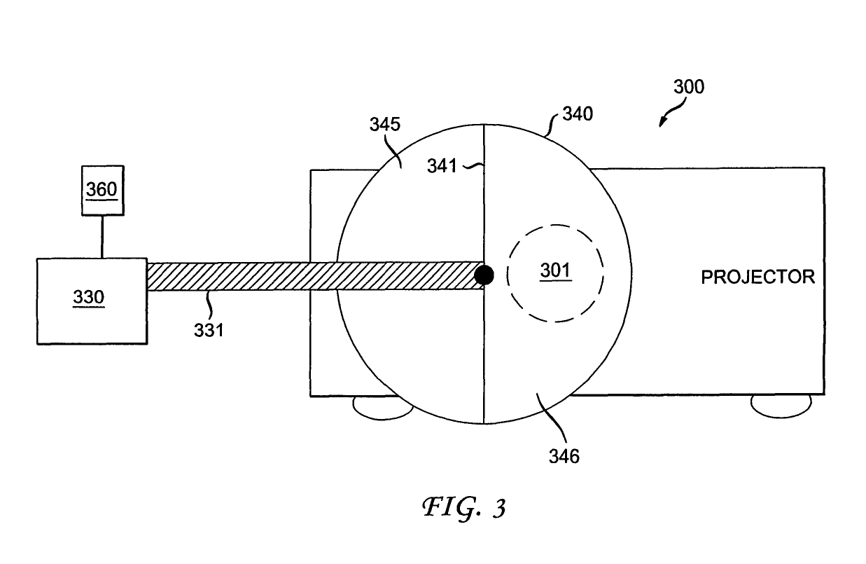

Turning to FIG. 3, another exemplary apparatus for upgrading a projector to display three-dimensional content is indicated generally by the reference numeral 300. The apparatus 300 includes a Direct Current (DC) motor 330, a circular polarized filter 340, and a user input device 360. The circular polarized filter 340 is manufactured and/or otherwise provided to have at least two polarized zones thereon, namely at least a first polarized zone 345 and a second polarized zone 346, with at least one edge 341 separating the at least two first and second zones 345 and 346.

The user input device 360 is connected in signal communication with the DC motor 330, and is used to control a speed at which the circular polarized filter is rotated around the shaft 331 of the DC motor 330. In this way, the DC motor 130 spins so that the attached circular polarized filter 340 is (manually) adjusted to spin at the proper speed which respectively places an appropriate one of the at least two polarized zones of the circular polarized filter 340 in front of an applicable frame of the video sequence to obtain a desired polarization thereof. For example, such speed can be equal to and/or other correspond to a frequency F and a time at which frames of a particular video sequence are projected during a sequential showing of the particular video sequence, as ascertained by, e.g., the user providing the user input.

It is to be appreciated that the user input device 360 can be a device that receives a user input and provide a respective output current and/or voltage responsive to the user input. Thus, for example, such user input device 360 can include a keyboard, buttons, a foot pedal, and/or so forth, where depending upon which key or button is depressed and/or an amount of displacement of, e.g., a key, button and/or the foot pedal, the output current and/or voltage provided to the motor 130 is adjusted accordingly. In other embodiments, a processor (not shown in FIG. 3, but shown in FIG. 1) can be used, where the user input (e.g., which key is pressed, how much are one or more keys depressed, and so forth) is judged by the processor in order to adjust (step up or step down) the current and/or voltage provided to the motor 350.

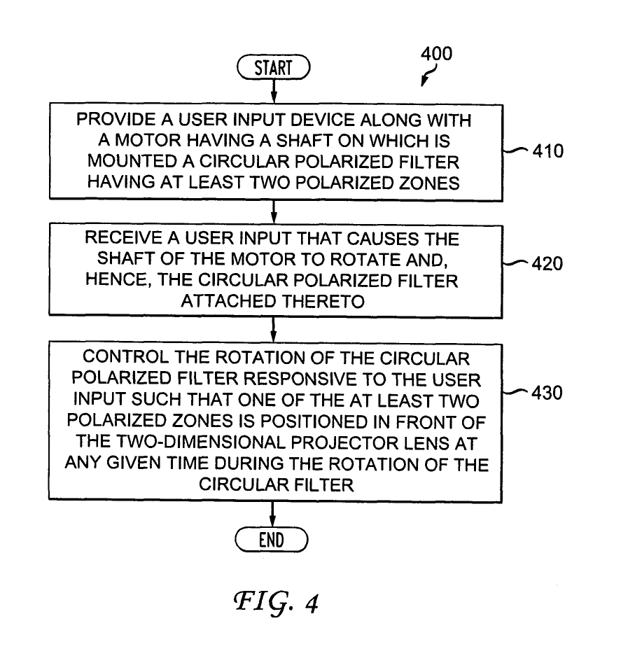

Turning to FIG. 4, another exemplary method for upgrading a projector to display three-dimensional content is indicated generally by the reference numeral 400. At step 410, a user input device 360 is provided along with a motor 330 having a shaft 331 on which is mounted a circular polarized filter 340 having at least two polarized zones. At step 420, a user input is received that causes the shaft 331 of the motor 330 to rotate and, hence, the circular polarized filter 340 attached thereto. At step 430, the rotation of the circular polarized filter 340 is controlled responsive to the user input such that one of the at least two polarized zones is positioned in front of the projector lens at any given time.

It is to be appreciated that while a Direct Current motor is described with respect to one or more embodiments of the present principles, the embodiments are not limited to DC motors and, thus, other types of motors can also be used in accordance with the teachings of the present principles, while maintaining the essence of the present principles.

It is to be further appreciated that one of the many advantages of the present principles is that manipulation of the projector is not required to upgrade the functionality of the projector. Moreover, it is to be appreciated that the zone between the two polarized filters can be opaque to avoid light from the projector coming through when the filter is alternating.

These and other features and advantages of the present principles can be readily ascertained by one of ordinary skill in the pertinent art based on the teachings herein. It is to be understood that the teachings of the present principles can be implemented in various forms of hardware, software, firmware, special purpose processors, or combinations thereof.

Most preferably, the teachings of the present principles are implemented as a combination of hardware and software. Moreover, the software can be implemented as an application program tangibly embodied on a program storage unit. The application program can be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform can also include an operating system and microinstruction code. The various processes and functions described herein can be either part of the microinstruction code or part of the application program, or any combination thereof, which can be executed by a CPU. In addition, various other peripheral units can be connected to the computer platform such as an additional data storage unit and a printing unit.

It is to be further understood that, because some of the constituent system components and methods depicted in the accompanying drawings are preferably implemented in software, the actual connections between the system components or the process function blocks can differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications can be effected therein by one of ordinary skill in the pertinent art without departing from the scope of the present principles. All such changes and modifications are intended to be included within the scope of the present principles as set forth in the appended claims.

1. An apparatus for displaying three-dimensional content from a projector, comprising:
a circular polarized filter having at least two polarized zones, wherein the circular polarized filter is rotatable in proximity of a projector lens;
at least one light sensor disposed in front of the projector lens that provides a spatial control output signal and a temporal control output signal; and
a processor for controlling a speed at which the circular polarized filter is rotated in response to an output signal of the at least one light sensor to place an appropriate one of the at least two polarized zones of the circular polarized filter in front of an applicable frame of a video sequence to obtain a polarization representative of the three-dimensional content.

2. The apparatus of claim 1, wherein the at least one light sensor comprises a first light sensor disposed in proximity of the projector lens that provides the temporal control output signal from which are determined a frequency at which frames of a video sequence are projected during a sequential showing of a particular video sequence and a time instant at which a particular frame from the video sequence is projected during the sequential showing.

3. The apparatus of claim 2, wherein the frequency and the time instant are determined from the temporal control signal output signal responsive to one or more criterion, the one or more criterion comprising an inclusion of one or more newly displayed objects or an omission of one or more previously displayed objects in a currently displayed frame.

4. The apparatus of claim 2, wherein the speed at which the circular polarized filter is rotated is equal to the frequency.

5. The apparatus of claim 1, wherein the at least one light sensor comprises a second light sensor disposed in proximity of the projector lens for providing the spatial control output signal from which is determined a time instant at which an edge between the at least two polarized zones of the circular polarized filter crosses a particular point.

6. The apparatus of claim 1, wherein the circular polarized filter comprises an opaque portion, disposed in between the at least two polarized zones, to prevent light from passing through.

7. A method for displaying three dimensional content on a projector, comprising:
rotating a circular polarized filter having at least two polarized zones in front of the projector;
extracting a spatial control signal and a temporal control signal from at least one sensor in proximity of the projector; and
controlling a speed at which the circular polarized filter is rotated in response to an output signal of the at least one sensor to place an appropriate one of the at least two polarized zones in front of a projected applicable frame of a video sequence to obtain a polarization representative of the three-dimensional content.

8. The method of claim 7, further comprising the step of:
determining a frequency at which frames of a video sequence are projected during a sequential showing of a particular video sequence and a time instant at which at a particular frame from the video sequence is projected during the sequential showing responsive to the temporal control signal.

9. The method of claim 8, further comprising the step of:
determining the frequency and the time instant from the temporal control signal responsive to one or more criterion, the one or more criterion comprising an inclusion of one or more newly displayed objects or an omission of one or more previously displayed objects in a currently displayed frame.

10. The method of claim 8, further comprising the step of:
rotating the circular polarized filter at a speed equal to the frequency.

11. The method of claim 7, further comprising the step of:
determining a time instant at which at least one edge between the at least two polarized zones of the circular polarized filter crosses a particular point responsive to the spatial control signal.

12. An apparatus for displaying three-dimensional content from a projector, comprising:
a circular polarized filter having at least two polarized zones, wherein the circular polarized filter is rotatable in proximity of a projector lens; and
a user input device that receives a user input and controls a speed at which the circular polarized filter is rotated,
wherein the circular polarized filter is spun responsive to the user input to place an appropriate one of the at least two polarized zones of the circular polarized filter in front of an applicable frame of a video sequence to obtain a polarization representative of the three-dimensional content.

13. The apparatus of claim 12, wherein the user input device comprises a processor for judging the user input to provide a judgment result and controlling the speed responsive to the judgment result.

14. A method for displaying three-dimensional content on a, comprising:
rotating a circular polarized filter having at least two polarized zones in front of the projector;
receiving a user input and controlling a speed at which the circular polarized filter is rotated,
wherein the circular polarized filter is rotated responsive to the user input to place an appropriate one of the at least two polarized zones of the circular polarized filter in front of an applicable projected frame of a video sequence to obtain a polarization representative of the three-dimensional content.
